(19) United States
(12) Patent Application Publication
(10) Pub. No.: US 2015/0160543 A1
(43) Pub. Date: Jun. 11, 2015

(54) MOBILE MICROPROJECTOR

(71) Applicant: Robert Bosch GmbH, Stuttgart (DE)

(72) Inventors: Stefan LEIDICH, Rutesheim (DE); Lutz RAUSCHER, Reutlingen (DE); Ingo HERRMANN, Friolzheim (DE)

(21) Appl. No.: 14/567,365

(22) Filed: Dec. 11, 2014

(30) Foreign Application Priority Data
Dec. 11, 2013 (DE) 10 2013 225 566.7

(51) Int. Cl. G03B 21/28; G02B 27/20

(52) U.S. Cl. CPC G03B 21/28; G02B 27/20

(57) ABSTRACT

A mobile microprojector is provided to include at least one deflectable micromirror for scanning a projection surface with the aid of a light beam, as well as a control unit for controlling the movements of the micromirror, the control unit being configured to effectuate at least one deflection of the micromirror via a first amplitude in a first operating state for scanning the projection surface. The control unit is configured to effectuate the deflection of the micromirror via a second amplitude in a second operating state, the second amplitude being smaller than the first amplitude.

### FIELD OF THE INVENTION

The present invention is directed to a mobile microprojector including at least one deflectable micromirror for scanning a projection surface with the aid of a light beam, as well as a control unit for controlling the movements of the micromirror, the control unit being configured to effectuate at least one deflection of the micromirror via a first amplitude in a first operating state for scanning the projection surface.

### BACKGROUND INFORMATION

The use of red or green laser pointers for highlighting contents during presentations is known. Laser pointers are generally pen-shaped devices having small batteries or coin cell batteries as the power supply. It occasionally happens that the batteries are empty, or are established to be empty, exactly when the laser pointer is to be used. Spare batteries are in this case hardly ever directly at hand. The laser pointer is generally kept together with pens or in the notebook case. A plurality of situations is conceivable or known in which a laser pointer is not available, but would be needed. The implementation of the laser pointer function in a smart phone solves the above-named availability problems.

### SUMMARY

An object of the present invention is the implementation of a laser pointer in a smart phone which is equipped with a projector on the basis of flying spot technology and has an expanded functionality with regard to the trivial activation of the lasers in stationary deflection mirrors.

The present invention is directed to a mobile microprojector including at least one deflectable micromirror for scanning a projection surface with the aid of a light beam, as well as a control unit for controlling the movements of the micromirror, the control unit being configured to effectuate at least one deflection of the micromirror via a first amplitude in a first operating state for scanning the projection surface. The core of the present invention is that the control unit is configured to effectuate the deflection of the micromirror via a second amplitude in a second operating state, the second amplitude being smaller than the first amplitude. A display of an image content having an increased light density is advantageously made possible in this way.

One advantageous embodiment of the mobile microprojector according to the present invention provides that the control unit is configured in such a way that the scanning of the projection surface takes place on a trajectory in rows, the rows run in parallel to a direction x of the deflection, and the rows are shorter in the second operating state than in the first operating state in that the second amplitude is smaller than the first amplitude. In this way, the light density on the row is advantageously increased in that individual image points move together on the row. It is also advantageous that the luminous period per image point is increased since the corresponding trajectory section is run through more slowly.

One advantageous embodiment of the mobile microprojector according to the present invention provides that the control unit is configured in such a way that the scanning of the projection surface takes place on a trajectory in rows, the rows run essentially perpendicularly to a direction y of the deflection, and the number of rows is smaller in the second operating state than in the first operating state, the second amplitude being smaller than the first amplitude. In this way, the light density is advantageously increased in that a higher image repetition frequency is made possible on the trajectory as a result of the reduced number of rows at the same velocity of the light beam.

One advantageous embodiment of the mobile microprojector according to the present invention provides that the control unit is configured in such a way that the scanning of the projection surface takes place on a trajectory in rows, the rows run essentially perpendicularly to a direction y of the deflection, and a row pitch is smaller in the second operating state than in the first operating state. In this way, the light density is advantageously increased in that a point distance of image points is also reduced as a result of the reduced row pitch.

One advantageous embodiment of the mobile microprojector according to the present invention provides that the control unit is configured in such a way that the second amplitude is zero. The y deflection may be advantageously turned off or reduced to a single row, so that the light density is increased in that only one row is scanned at a maximum image repetition rate.

A hand-held laser pointer including a mobile microprojector as the one described above is advantageous, a display object (300), which is smaller than the projection surface (60), being displayable in the second operating state. Advantageously, a laser pointer having a high light intensity may be emulated in this way.

It is also advantageous that the laser pointer has at least one inertial sensor for detecting the movements of the laser pointer in space, and that the control unit is configured to compensate for the movements of the display object on the projection surface in the second operating state, a first movement component which runs along the rows being compensated for by a displacement of image data on the rows and a second movement component which runs perpendicularly to the rows being compensated for by a reverse deflection of the micromirror. In this way, shaking of the hand during the utilization of the hand-held laser pointer may advantageously also be compensated for, for example.

It is also advantageous that the laser pointer has at least one inertial sensor for detecting the movements of the laser pointer in space and that the control unit is configured to display these movements in the form of an altered display object, in particular of a deformed and/or animated display object, in the second operating state. In this way, movements of the hand-held laser pointer are advantageously additionally visualized.

The present invention relates to the use of a smart phone including a microprojector on the basis of laser projection (flying spot) for the implementation of a laser pointer having a functionality range which is expanded with regard to conventional laser pointers. For this purpose, a novel writing method (trajectory of the laser spot deflection) is used in order to be able to vary the position of the displayed laser spot and to be able to overcome the disadvantage of an excessively low brightness which usually results therefrom.

In addition to the general advantage of the availability of a laser pointer in a smart phone including a projector without (relevant) additional costs, further features may be implemented with the aid of the implementation according to the present invention. Since the spot or the object may be placed arbitrarily in the horizontal and vertical directions (within the possible projection area), a shaking of the hand may be completely compensated for. Due to the inertial sensors (acceleration sensor, rotation rate sensor) present in many smart phones, the required measuring signals are available without additional costs.

It is furthermore possible to display a plurality of spots or objects at the same brightness. Due to the required limitation to a limited number of rows, the multiple display of objects is, however, limited to the horizontal direction. By turning the device and using appropriate software, it is presumably possible to neutralize this limitation.

The availability of the inertial measuring values also makes possible an adaptive design of the projected object as a function of the position and movements of the laser pointer. Therefore, an arrow might, for example, change its color or shape during the movement of the laser pointer. Moving spheres might be displayed elliptically to simulate a “resilience of the material.” In the case of the display of a filled glass, drops might squirt during movement. Furthermore, many other effects are implementable which are also implementable as an app.

The described functions are generally not implementable together with other possible implementation concepts of microprojectors, since other methods (not flying spot) do not offer the possibility of concentrating the light power of the source on an area which is smaller than the regular projection surface.

### BRIEF DESCRIPTION OF THE DRAWINGS

FIG. 1 shows a trajectory of a microprojector according to the related art.

FIG. 2 shows a microprojector according to the present invention.

FIG. 3 shows a trajectory in the second operating state of a microprojector according to the present invention in a first exemplary embodiment.

FIG. 4 shows a trajectory in the second operating state of a microprojector according to the present invention in a second exemplary embodiment.

FIG. 5 shows a trajectory in the second operating state of a microprojector according to the present invention in a third exemplary embodiment.

FIG. 6 shows a trajectory in the second operating state of a microprojector according to the present invention in a fourth exemplary embodiment.

FIG. 7 shows a microprojector according to the present invention including an inertial sensor.

### DETAILED DESCRIPTION

Known light pointer pens (laser pointers) use laser diodes having a power of 1 mW. Devices having 5 mW are already considered to be critical with respect to eye safety.

Laser projectors for smart phones have a laser source which may make available a light power of approximately 300 mW-400 mW. For the projection of a consistently bright image, approximately half of the power is used (150 mW-200 mW).

A laser spot may naturally be generated in two ways. First, by deactivating the movement of the deflection mirrors and by reducing the laser power. Or secondly, by projecting an image having only one activated pixel.

The first approach has the disadvantage that only a fixed spot may in principle be generated. A movement of the spot, e.g., to compensate for the shaking of a hand, cannot be implemented. The projection of a graphic element (arrow or square) cannot be implemented either.

The second approach has the disadvantage that the brightness of the spot is limited to the proportional pixel brightness. In the case of a resolution of 800×600 image points, for example, the laser power of the individual pixel is only 0.0004 mW. The visibility of the spot on a projected image of a regular conference room projector is therefore non-existent.

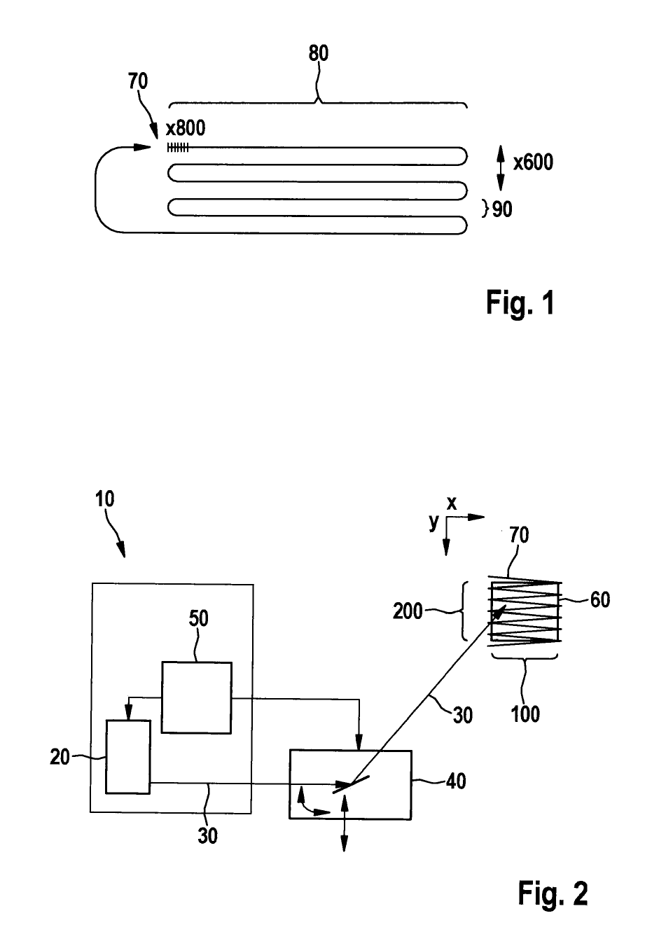

FIG. 1 shows a trajectory 70 of a microprojector according to the related art. In this case, a microprojector is involved which has at least one deflectable micromirror for scanning a projection surface 60 (flying spot technology). The scanning of projection surface 60 takes place row by row. For this purpose, the mirror is deflected dynamically at its natural frequency in a direction x for scanning a row 80, so that this mirror oscillates at this frequency and at a fixed first amplitude 100 in direction x. In addition, the mirror is deflected quasistatically in a direction y, which is situated essentially perpendicularly to direction x, in order to scan another row 80. Rows 80 have a row pitch 90 which is determined by the degree of the deflection in direction y. By multiplying the number of rows 80 by row pitch 90, a first amplitude 110 in direction y is obtained.

For technical reasons, it is not possible to statically approach a certain point with the aid of the deflection device. The deflection of the laser spot takes place almost exclusively according to the illustrated pattern. This trajectory is described, inter alia, in the unexamined patent application US2011069084A1.

The drive of the mirror for the horizontal deflection (direction x) takes place resonantly at a frequency of 20 kHz-40 kHz in order to reduce the drive forces to a technically reasonable level. Accordingly, it is in general not possible to statically set a fixed angle outside of the center. The vertical deflection (direction y) takes place quasistatically at a frequency of usually 60 Hz-120 Hz. In the vertical direction, any arbitrary angle of the deflection may be set statically.

FIG. 2 shows a microprojector according to the present invention. Illustrated is a mobile microprojector 10 including a deflectable micromirror 40 for scanning a projection surface 60 with the aid of a light beam 30, as well as a control unit 50 for controlling the movements of micromirror 40. Control unit 50 is configured to effectuate at least one deflection of micromirror 40 via a first amplitude 100 or also 110 in direction x or y in a first operating state for scanning projection surface 60. Mobile microprojector 10 has a light source 20 which is, for example, one or multiple laser diode(s). According to the present invention, control unit 50 is configured to effectuate the deflection of micromirror 40 via a second amplitude 200 or also 210 in a second operating state, second amplitude 200, 210 being smaller than first amplitude 100, 110. In the present exemplary embodiment, the micromirror is deflectable in two axes, so that it may deflect a light beam 30 on a trajectory 70 in horizontal direction x on a row 80 as well as in vertical direction y for generating a row pitch 90. Alternatively, it is also possible to situate two micromirrors for separately deflecting the light beam in one axis in each case.

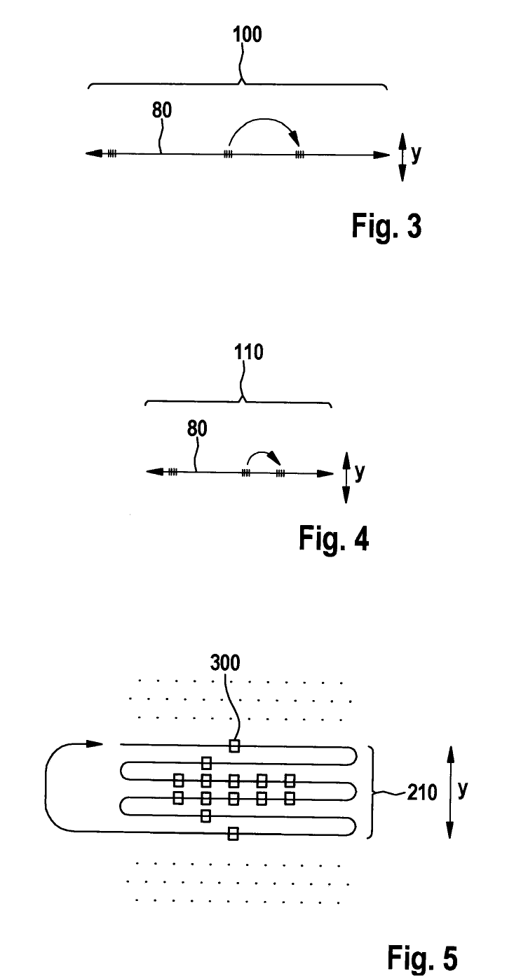

FIG. 3 shows a trajectory in the second operating state of a microprojector according to the present invention in a first exemplary embodiment. Illustrated is a projection surface 60 having a trajectory 70 including only one row 80 on which the laser beam is deflected in direction x. Here, horizontal deflection x is continuously driven (resonantly) harmonically. In this exemplary embodiment, control unit 50 is configured in such a way that vertical deflection y is fixed to a settable angle. Therefore, second amplitude 210 is reduced in direction y with regard to first amplitude 110, namely to zero. The distribution of the laser power to an individual pixel thus takes place only using the horizontal resolution as the divider. In the case of a resolution of 800×600 in a first operating state of the microprojector, the laser power of the individual pixel is therefore 200 mW/800=0.25 mW in the exemplary embodiment of a second operating state illustrated here. A corresponding light spot is well visible under usual surrounding conditions. By using two directly adjacent pixels, the power would be increased to 0.5 mW. In this case, the light spot would have an ellipticity of 2:1. In the case of a typical design, the light spot located at a 5 m distance would have a width of 10 mm and a height of 5 mm.

FIG. 4 shows a trajectory in the second operating state of a microprojector according to the present invention in a second exemplary embodiment. Illustrated is a projection surface 60 having a trajectory 70 including only one row 80 on which the laser beam is deflected in direction x. Here, horizontal deflection x is continuously driven on its natural frequency. However, the row length is reduced in contrast to the first exemplary embodiment. In this exemplary embodiment, control unit 50 is configured in such a way that in direction x, second amplitude 200 is also reduced with regard to first amplitude 100. In this case, the ellipticity may thus be reduced by reducing the horizontal deflection angle. It is therefore possible, for example, to use more pixels (or more “laser time”) for the projection of the spot. In practice, this measure may be subject to limitations, since the control of the drive is optimized to a certain amplitude in direction x.

FIG. 5 shows a trajectory in the second operating state of a microprojector according to the present invention in a third exemplary embodiment. In contrast to the first two exemplary embodiments in FIGS. 3 and 4, second amplitude 210 is also reduced in direction y with regard to first amplitude 110, but it is greater than zero. In the case of constant row pitch 90, as shown in FIG. 1, control unit 50 is now rather configured in such a way that multiple rows 80 are illustrated in this case. By writing a plurality of rows, e.g., 4 or 6 rows, simple objects such as arrows or squares may be displayed. As illustrated in FIG. 5, an arrow may, for example, have 14 pixels which are situated in 6 rows. In this case, the laser power would be 200 mW/800/6*14=0.6 mW, and the object would thus also be well visible. The illustrated arrow would have a width of approximately 30 mm at a distance of 5 m.

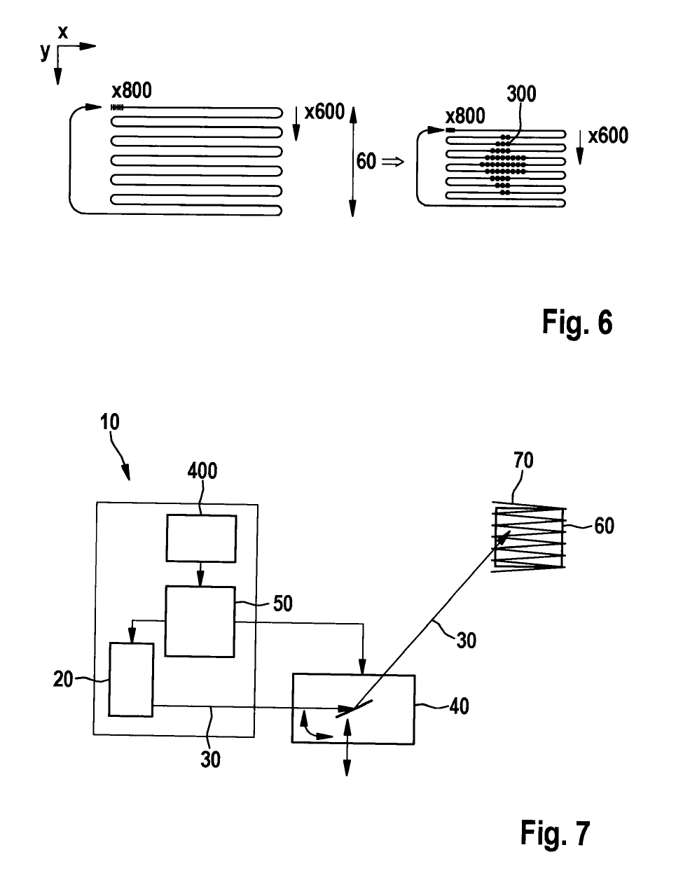

FIG. 6 shows a trajectory in the second operating state of a microprojector according to the present invention in a fourth exemplary embodiment. In contrast to the first two exemplary embodiments in FIGS. 3 and 4, second amplitude 210 is also reduced in direction y with regard to first amplitude 110, but it is greater than zero. Furthermore, in contrast to the third exemplary embodiment, control unit 50 is configured in such a way that multiple rows 80 are illustrated, row pitch 90 being, however, reduced with regard to the trajectories in FIGS. 1 and 5. The number of rows 80 may be provided in this case up to complete resolution, for example, as in the first operating state. By writing the regular number of rows (approximately 600) having a considerably smaller vertical deflection angle (e.g., 6°/800*6=0.045°), a simple object such as an arrow or another display object may be displayed, just as shown in FIG. 5. To roughly compute the light power, it may be assumed, for example, that the straight line of the arrow includes 200 rows and 6 columns. The tip of the arrow is constructed in each case from 200 rows having an average of 4 pixels. 200 mW/800/600*2800=1.2 mW of optical power is assigned to 200×6+2×200×4=2800 pixels. The display of the arrow is thus sufficiently bright for the purpose of contrasting from the light of the surroundings, in particular also from another display which is projected by a conventional projector.

FIG. 7 shows a microprojector according to the present invention including an inertial sensor. In addition to the features shown in FIG. 2, this microprojector also includes at least one inertial sensor 400, the signals of which are supplied to control unit 50. In this exemplary embodiment, control unit 50 is configured in such a way that in the second operating state, the movements of the microprojector are compensated for by a corresponding reverse displacement of the projected object on the projection surface. Alternatively, control unit 50 is configured in such a way that in the second operating state, the movements of the microprojector are visualized with the aid of an altered display object, in particular a display object which is deformed or animated with regard to a first motionless form.

The present invention also includes a hand-held laser pointer including a mobile microprojector 10 as described above, control unit 50 being configured in such a way that in the second operating state, a display object 300 is displayable which is smaller than projection surface 60.

In summary, the present invention causes an increase in the light density by reducing or compressing the projection surface in the second operating state with regard to the regular or maximally possible projection surface in the first operating state. For a microprojector which scans the projection surface row by row with the aid of a deflectable micromirror, this is possible in the following ways:

The micromirror is dynamically driven at its natural frequency in direction x and kept with a fixed deflection in direction y. In this way, the trajectory is reduced to a single row. In addition, the amplitude in direction x may be reduced, thus shortening the row. More generally, the amplitude in direction y may be reduced in the second operating state, either the number of rows being reduced with regard to the first operating state or the display being compressed by reducing the row pitch.

One additional benefit results when the microprojector additionally includes inertial sensors which detect its position in space or its movements. The signals of the inertial sensors may be used to compensate for the movements, such as shaking of the hand, of the hand-held microprojector or of a laser pointer including a microprojector according to the present invention. As a result, the projection appears to the user as still and stationary.

This is possible with the aid of the following measures: Within the scope of the imaging procedure, a light point or pixel may be arbitrarily placed on the trajectory by turning the light source on and off in a manner determined as a function of time. This is possible in direction x on the row as well as in direction y for selecting the row.

Alternatively or in the case of displaying only one row, the movement in direction y may also be compensated for by a reverse quasistatic deflection of the micromirror and thus by a displacement of the trajectory.

What is claimed is:

1. A mobile microprojector, comprising:
at least one deflectable micromirror for scanning a projection surface with the aid of a light beam; and
a control unit for controlling a movement of the micromirror, wherein the control unit effectuates at least one deflection of the micromirror via a first amplitude in a first operating state for scanning a projection surface, and wherein the control unit effectuates the deflection of the micromirror via a second amplitude in a second operating state, the second amplitude being smaller than the first amplitude.

2. The mobile microprojector as recited in claim 1, wherein:
the control unit is configured in such a way that the scanning of the projection surface takes place on a trajectory in rows,
the rows run in parallel to a direction x of the deflection, and
the rows are shorter in the second operating state than in the first operating state in that the second amplitude is smaller than the first amplitude.

3. The mobile microprojector as recited in claim 1, wherein:
the control unit is configured in such a way that the scanning of the projection surface takes place on a trajectory in rows,
the rows run essentially perpendicularly to a direction y of the deflection, and
the number of rows is smaller in the second operating state than in the first operating state, the second amplitude being smaller than the first amplitude.

4. The mobile microprojector as recited in claim 1, wherein:
the control unit is configured in such a way that the scanning of the projection surface takes place on a trajectory in rows,
the rows run essentially perpendicularly to a direction y of the deflection, and
a row pitch is smaller in the second operating state than in the first operating state, the second amplitude being smaller than the first amplitude.

5. The mobile microprojector as recited in claim 1, wherein the control unit is configured in such a way that the second amplitude is zero.

6. A hand-held laser pointer, comprising:
a mobile microprojector, including:
at least one deflectable micromirror for scanning a projection surface with the aid of a light beam, and
a control unit for controlling a movement of the micromirror, wherein the control unit effectuates at least one deflection of the micromirror via a first amplitude in a first operating state for scanning a projection surface, wherein the control unit effectuates the deflection of the micromirror via a second amplitude in a second operating state, the second amplitude being smaller than the first amplitude, and wherein the control unit is configured in such a way that in the second operating state, a display object is displayable that is smaller than the projection surface.

7. The hand-held laser pointer as recited in claim 6, wherein the hand-held laser pointer is a smart phone.

8. The hand-held laser pointer as recited in claim 6, further comprising:
at least one inertial sensor for detecting a movement of the laser pointer in space, wherein:
the control unit compensates for a movement of the display object on the projection surface in the second operating state,
a first movement component that runs along rows is compensated for by displacement of image data on the rows, and
a second movement component that runs perpendicularly to the rows is compensated for by reverse deflection of the micromirror.

9. The hand-held laser pointer as recited in claim 6, further comprising:
at least one inertial sensor for detecting a movement of the laser pointer in space, wherein the control unit is configured to display the movement of the laser pointer in the form of an altered display object in the second operating state.

10. The hand-held laser pointer as recited in claim 9, wherein the altered display object includes one of a deformed display object and an animated display object.
